(19) United States
(12) Patent Application Publication
(10) Pub. No.: US 2005/0212163 A1
(43) Pub. Date: Sep. 29, 2005

(54) Component build up in layers and process for production thereof

(76) Inventors: Holger Bausinger, Stuttgard (DE); Michael Nitz, Reute (DE); Jialin Shen, Bernstadt (DE); Didier von Zeppelin, Ulm (DE)

Correspondence Address: PENDORF & CUTLIFF, 5111 Memorial Highway, Tampa, FL, 33634-7356, US

(21) Appl. No.: 11/089,290

(22) Filed: Mar. 24, 2005

(30) Foreign Application Priority Data
Mar. 24, 2004 (DE) 10 2004 014 806.6

(51) Int. Cl. B29C 35/08; B29C 41/02; B32B 9/00

(52) U.S. Cl. 264/113; 264/497; 428/701

(57) ABSTRACT

Components build up of layers can be produced by means of the so-called three dimensional printing process from plaster or cement powder. It is the task of the present invention to provide another component build up in layers and a process for production thereof, which component exhibits at least comparable strength and at most the same manufacturing cost. The task is solved thereby, that the component is a reaction product of a particulate material and an aqueous liquid, wherein the component includes a number of layers of the reaction product, and wherein the particulate material contains plaster-free cement.

### BACKGROUND OF THE INVENTION

1. Field of the Invention

The invention concerns a component built up stepwise and a process for production thereof according to the precharacterizing portion of Patent claims 1 and 5. This general type of component and process are already known from WO 00/26026.

2. Related Art of the Invention

Components built up in layers and processes for their manufacture are known under the term “rapid” technologies (rapid prototyping, rapid manufacturing, rapid tooling . . . ). Examples for this type of process include the so-called selective laser sintering or the three dimensional printing process as described for example in WO 00/26026.

In WO 00/26026 a plaster component built up in layers and a process for production thereof is described. The term plaster includes any material which has a substantial component of CaSO₄·½H₂O.

According to WO 00/26026 a powder plaster is applied together with organic components such as adhesive, humectant or the like, is selectively printed with water and is solidified by crystallization. The process is repeated for multiple sequential steps for producing a three dimensional component.

Components built in this manner exhibit a sufficient stability for most applications. In high tempered applications, however, the organic ingredients evaporate, and as a result the quality of the component and the environment is degraded.

### SUMMARY OF THE INVENTION

It is the task of the present invention to provide a component built up in layers and a process for manufacture thereof, which exhibit at least a similar degree of solidity with at most the same manufacturing costs and which require no, or at least less, organic ingredients.

The invention is accomplished, with regard to the component to be produced and the process for manufacture to be provided, by the characteristics of Patent claim 1 and 6. The remaining claims contain advantageous embodiments and further developments of the inventive component (Patent claims 2 through 5) and process (Patent claim 7).

With regard to the component to be created, the task is inventively solved thereby, that it is constituted as a reaction product of a particulate material and an aqueous liquid, wherein the component comprises a plurality of layers of the reaction product, and wherein the particulate material contains CaSO₄-free cement.

A component of this type provides an economical and qualitatively high value alternative to the components according to WO 00/26026. The addition of organic components is not necessary in accordance with the invention, however it is possible.

The term “cement” is defined in European norms (industrial standards) EN 197-1 and 2 and includes active SiO₂ and CaO as main components. CaSO₄ is not a major or minor component of cement. CaSO₄ is however added for reasons including controlling solidification.

In accordance with the invention the particulate material contains CaSO₄-free cement. CaSO₄-free means, herein, as free as possible, that is, the presence of insubstantial traces (less than or equal to 1 weight percent) of CaSO₄ in cement is not ruled out, however is kept as small as it is possible to produce economically.

In one preferred embodiment of the invention the particulate material contains quick hardening cement, preferably rapid hardening cement (reference code FE or SE according to DIN 1164-11). Thereby the manufacture of the component is accelerated and the component quality is improved.

In a further advantageous embodiment of the inventive component the particulate material is fine grained, preferably finest grain, in particular ultra-finest grain. These terms are defined as
Fine grain: d95≦60 μm and d50≦20 μm,
   preferably with d50 to d95=0.33±0.04
Finest grain: d95≦24 μm and d50≦8 μm,
   preferably with d50 to d95=0.33±0.04
Ultra Finest
grain: d95≦16 μm and d50≦5 μm,
   preferably with d50 to d95=0.33±0.04
      with d95=particle diameter when 95 weight percent of particles pass through the sieve and with d50=particle diameter when 50 weight percent of the particles pass through the sieve.

This type of fine cement, in particular finest cement, exhibits a low water requirement and hydrates more rapidly. Components produced therewith possess a lower porosity and higher pressure stability, their texture is tighter and more homogenous than products with commercial normal particle size distribution.

In particular for fine and finest particle ranges the incorporation of CaSO₄ must be avoided, since in the conventional manufacturing processes for cement CaSO₄ can accumulate in not reproducible manner in these particle fractions, whereby a consistent and reproducible construction quality cannot be guaranteed.

In a further advantageous embodiment of the inventive component the particulate material includes filler, preferably refractory oxide, in particular the oxide and/or mixed oxides of the elements Al, Zr, Si, Mg, Ca or Ti, or refractory carbides or nitrides of the elements Si and/or Ti. Particularly referred are ZrSiO₄, Al₂O₃, SiC and/or ZrO₂. This type of filler is particularly good for adjusting the solidity and gas permeability of the component.

Preferably the particulate material contains 20 to 75 weight percent filler. Thereby the application specific required component solidity can be adjusted over a sufficiently large spectrum.

In a further advantageous embodiment of the inventive component the particulate material contains dispersing agents, preferably a naphthalene sulfonate formaldehyde condensate.

Thereby the formation of homogenous layers is promoted. This type of dispersing agent or dispersing assistant may however not exceed, as component of the cement composition, 5 weight percent, perferably 3 weight percent, since above this an intolerable loss in rigidity, in particular a loss in pressure stability, would result.

In a further preferred embodiment of the inventive component the particulate material contains water scavengers or hygroscopic materials, for example methylcellulose, PVP or PVA.

In a further preferred embodiment of the inventive component the particulate material includes solidification accelerators, in particular aromatic sulfonic acids and their sodium compounds or calcium sulfoaluminate, calcium formiate, sodium aluminate, calcium chloride or thiocyanate (rhodanide).

In a particularly preferred embodiment of the inventive component the particulate material contains filler particles, which are coated with additives such as, for example, dispersing aids and/or hygroscopic materials and/or hardening accelerators. By coating the filler particles the distribution of the additives is evened out and the amount necessary is reduced, so that their total proportion is generally less than 2 weight percent, in exceptional cases less than 4 weight percent.

In a further advantageous embodiment the inventive component is a casting mold.

The cost advantage of the inventive component is particularly pronounced in casting molds. Beyond this, in accordance with the invention, no organic ingredients are required. The absence thereof makes possible an optimal casting process, which would otherwise be impaired by the evaporation of organic ingredients. Beyond this, in particular by the addition of the filler amounts, a desired gas permeability of the component, in particular the casting mold, can be adjusted. This simplifies the off-gassing of the cast material.

This task is inventively achieved, with regard to the process to be provided, by producing a component in accordance with the invention by the following steps:
producing a first layer of particulate material,
applying an aqueous liquid on this first layer,
allowing a reaction of at least a part of the particulate material and the aqueous liquid for forming an at least partially solidified first layer,
producing a second layer of particulate material,
applying the aqueous liquid upon the second layer,
allowing a reaction of at least a part of the particulate material and the aqueous liquid for forming a solid component including at least parts of the first and second layer, wherein
particulate material according to one of the above described embodiments is employed in making the inventive component.

A process of this type provides an economical and qualitatively high value alternative to the process according to WO 00/26026.

In a further advantageous embodiment of the inventive process the solidification is accelerated by heating.

The actual crystallization reaction occurs exothermically, however the activation energy necessary for initiation can be introduced by external heat. Promoting of this type is not possible in the process according to WO 00/26026 since the evaporation of the organic components would interfere with an even solidification process.

Another possibility is comprised in the addition of chemical solidification accelerators, for example CaCl₂, aromatic sulfonic acids and their sodium compounds or calcium sulfoaluminate, calcium formiate, sodium aluminate or rhodanide. Their addition should not exceed 1 weight percent, preferably 0.5 weight percent.

A particularly preferred application of CaSO₄-free cement according to the above description is in a rapid prototyping processes, in particular a three dimensional printing process.

In the following the inventive component and the inventive process for production thereof will be described in greater detail on the basis of an illustrative embodiment:

According to the illustrative embodiment, as particulate material a fine particulate CaSO₄-free Portland cement is employed. As filler, 50 weight percent fine grain zirconium silicate is employed, evenly dispersed, with a particular size distribution of 20 to 80 μm. In a composition of this type the addition of dispersion aids is not necessary.

The high proportion of filler results in a comparatively low component stability of approximately 10 MPa; however, this is sufficient and advantageous for a casting processes. This type of component, particularly when used in difficult to access mold cores, can then be easily broken up and removed.

As solidification or hardening accelerators 500 ppm fine particle sodium aluminate as well as 1 weight percent fine particle PVP are added as hygroscopic agent.

This mixture is supplied as particulate building material in a conventional three dimensional printing process, by means of which a casting mold is built up following the above described 3D-data set by printing of multiple sequential particle layers with tap water. Therein, for the area to be printed, a water to cement weight relationship of approximately 1:3, or as the case may be, a water to solid weight relationship of approximately 1:6, is employed.

The thus produced casting mold is characterized by the almost complete absence of organic components, whereby an off-gassing during casting practically does not occur.

The inventive process and component have demonstrated themselves in the embodiments of the above described example as particularly suited for casting technical applications, in particular in the automotive industry.

Besides the avoidance of emissions, substantial cost advantages can be achieved.

The invention is not limited to the above described embodiment, but rather can be applied broadly.

Thus, for example, by the employment of quick hardening cement (reference code SE) the production time of the casting mold can be drastically shortened, as a result of which further cost savings result.

Beyond this, the cement is not advantageous only in manufacturing using three dimensional printing, but rather is suited for manufacturing using selective laser sintering, in particular the fine particle or finest particle cement.

1. A component produced from the reaction product of
a particulate material and an aqueous liquid,
wherein the component comprises a number of layers of the reaction product, and
wherein the particulate material includes CaSO₄-free cement.

2. The component according to claim 1, wherein the particulate material is fine particle material.

3. The component according to claim 1, wherein the particulate material includes fillers.

4. The component according to claim 1, wherein the particulate material includes a dispersing aid.

5. The component according to claim 1, wherein the component is a casting mold.

6. A process for producing a component including
producing a first layer of particulate material,
applying an aqueous liquid on this first layer,
allowing a reaction of at least a part of the particulate material and the aqueous liquid for forming an at least partially solidified first layer,
producing a second layer of particulate material,
applying the aqueous liquid upon the second layer,
allowing a reaction of at least a part of the particulate material and the aqueous liquid for forming a solid component including at least parts of the first and second layer,
the particulate material is a CaSO₄-free cement.

7. The process for producing a component according to claim 6, wherein solidification is accelerated by heating.

8. The rapid prototyping process employing a CaSO₄-free cement as solidifying material.

9. The component according to claim 2, wherein the particulate material is finest particle material.

10. The component according to claim 3 wherein the filler is at least one of refractory oxides, refractory carbides and refractory nitrides.

11. The component according to claim 10, wherein the refractory oxides are selected from the oxides and/or mixed oxides of the elements Al, Zr, Si, Mg, Ca or Ti, and wherein the refractory carbide or nitride is of the elements Si or Ti.

12. The component according to claim 4, wherein the dispersing aid is a naphthalene sulfonate formaldehyde condensate.
